(19) United States
(12) Patent Application Publication
(10) Pub. No.: US 2025/0059807 A1
(43) Pub. Date: Feb. 20, 2025

(54) LOCKING DEVICE

(71) Applicant: Magna BÖCO GmbH, Wuppertal (DE)

(72) Inventors: Ekkehard SCHUBE-MÖHRING, Essen (DE); Daniel DIPPONG, Balve (DE); Michael DIGEL, Wuppertal (DE)

(21) Appl. No.: 18/641,749

(22) Filed: Apr. 22, 2024

(30) Foreign Application Priority Data
Jul. 5, 2023 (DE) 10 2023 117 706.0
Sep. 1, 2023 (DE) 10 2023 123 600.8

(51) Int. Cl. E05B 85/04; E05B 79/02

(52) U.S. Cl. CPC E05B 85/04; E05B 79/02

(57) ABSTRACT

A locking device for a motor vehicle, including a striker that is fixed in a desired position on a mounting plate and that can be transferred from the desired position to a spaced-apart position in an accident situation as a result of a threshold force being exceeded. The mounting plate includes at least one opening through which an axial portion of the striker passes. The material regions of the mounting plate, which are arranged at a mouth of the opening, are deformed in abutment against the outer circumferential surface of the axial portion of the striker located in the desired position.

The invention first relates to a locking device according to claim 1.

The applicant has been involved in the development and manufacture of such locking devices for motor vehicles for many decades.

A generic locking device according to the prior art is disclosed in DE 10 2021 101 188 A1 by the applicant.

Claim 1 relates to a locking device for a motor vehicle. In the broadest sense, a motor vehicle within the meaning of the invention can be a passenger car or a commercial vehicle. In particular, the locking device can be used to lock a door element, e.g. a vehicle side door, a vehicle bonnet or a boot lid, or another movable part of the motor vehicle in a closed position firmly and securely relative to the vehicle body and to enable this door element to be opened if necessary. For this purpose, the locking device usually comprises a striker and a rotary latch. The rotary latch can hold the striker in the locking position, e.g. with a rotary latch jaw.

In a first variant, the striker can be arranged on the body side and the rotary latch can be arranged on the door side. A geometrically inverted arrangement is also covered by the invention.

In the event of a crash or accident, the door element or even the vehicle body can become deformed. In order to enable the door to be opened even after the accident, the prior art patent application described above already discloses the possibility of designing the striker to be displaceable in the event of a crash. In the prior art device, the striker is fixed in a desired position on a mounting plate and can be axially displaced in the event of a crash if the threshold forces are exceeded due to material deformation. As a result of the axial displacement, the door can be opened more easily after the crash.

The present patent application deals with fixing the striker to the mounting plate and adjusting the threshold force as precisely as possible.

In the prior art device, the striker has bead-like, deformable regions. If a load force is applied that exceeds a threshold value, these bead regions can deform and the striker can slip through the opening in the mounting plate and reach a spaced-apart position.

The prior art locking device fulfils all operational and legal requirements. Nevertheless, there is a need to develop this technology further.

Based on this, the object of the invention is to further develop the locking device in such a way that the precise setting of a threshold force is improved.

The invention achieves this object with the features of claim 1, in particular with those of the characterizing part, and is therefore characterized in that the mounting plate comprises at least one opening through which an axial portion of the striker passes, wherein material regions of the mounting plate, which are arranged at a mouth of the opening, are deformed in abutment against the outer circumferential surface of the axial portion of the striker located in the desired position.

The principle of the invention essentially consists of deforming material regions of the mounting plate to fix the striker to the mounting plate. According to the invention, those material regions of the mounting plate that are arranged at a mouth of the opening are deformed.

Deformation takes place in such a way that the material regions are deformed in contact with the outer circumferential surface of the striker, i.e. in contact with the outer circumferential surface of the axial portion of the striker. Deformation occurs when the striker is in the desired position, i.e. during assembly.

If, in the prior art, material regions of the striker were deformed in the event of a crash, material regions of the mounting plate are deformed according to the invention.

These desired deformation regions are therefore no longer arranged on the striker, as in the prior art, but are now located on the mounting plate.

In the context of the invention, a method can be used that utilizes a pusher body that is, for example, funnel-shaped. This funnel-shaped body can, for example, press on material regions of the mounting plate that are arranged near the mouth of an opening in the mounting plate as part of a wobbling movement and thus ensure a radial material flow—or a material closure that has a radial directional component—from material regions of the mounting plate inwards in relation to a central longitudinal axis of the axial portion of the striker. This constricts the mounting plate radially, so to speak, and clamps or presses the striker against it. This fastening as a result of a contact pressure fixes the striker securely to the mounting plate during the service life of the motor vehicle in the normal situation. In the event of a crash, if the threshold force is exceeded, this pressing, or press fit, or clamping, can be cancelled and the striker can slip through the opening or through the openings on the mounting plate and be transferred from the desired position to a spaced-apart position.

The locking device according to the invention thus comprises a modified mounting of the striker on the mounting plate compared to the prior art. Whereas in the prior art, only a bead-shaped expansion was provided on the striker, according to the invention, a corresponding clamping fit is achieved by deforming the mounting plate.

The method allows an optimized, very precisely defined material flow from material regions radially inwards. This allows the threshold force required to release the axial hold of the striker relative to the mounting plate in the event of a crash to be precisely set and defined.

The invention relates to a locking device for a motor vehicle, e.g. for a door lock or a bonnet lock. The locking device comprises a striker. This can be U-shaped or substantially U-shaped, for example.

The invention also includes strikers that are substantially axially elongated and comprise only one leg.

It is decisive for the invention that the striker according to the invention has at least one leg to which a rotary latch can be attached.

The locking device according to the invention provides that the striker is fixed in a target position on a mounting plate. The target position describes all normal states over the service life of the motor vehicle. Normally, i.e. without an accident situation occurring, the striker is immovable, i.e. axially fixed to the mounting plate in relation to the mounting plate.

In the event of an accident or crash, a force may be exerted on the striker in the axial direction. An accident situation can occur, for example, if deformation occurs as a result of the motor vehicle colliding with another object, obstacle or vehicle, e.g. deformation of the door or deformation of the bodywork. However, an accident situation of the present patent application also includes the case in which a safety device, e.g. a pedestrian protection device, of the motor vehicle detects a dangerous situation and, for example, actuates an actuator that displaces the door, e.g. a bonnet of the motor vehicle, and, for example, transfers it to a pedestrian protection position in which, for example, a spaced-apart position from the bodywork is reached in order to provide a crumple zone for a pedestrian accident.

In an accident situation, the striker can be displaced from the target position relative to the mounting plate by exerting an axial force on the striker and transferred to a spaced-apart position.

The spaced-apart position can be achieved by displacing the striker along a travel path of, for example, more than 10 mm, for example more than 30 mm, in particular more than 40 mm, for example more or in particular more than 50 mm.

Such a displacement of the striker from the desired position to the spaced-apart position is only possible as a result of a threshold force being exceeded. The threshold force can be between 1 kN and 3 kN, for example. However, these values are merely exemplary.

The mounting plate has at least one opening. It can also have two or more openings.

The mounting plate has material regions, which are arranged at the mouth of the opening. The material regions therefore surround the mouth of the opening or provide the mouth edge region on the mounting plate side. An axial portion of the striker reaches or passes through the opening.

In the course of manufacturing the closure device, pressure is exerted on the material regions with the aid of a pusher body, which in particular performs a wobbling movement, such that they flow radially inwards. The material is thus deformed. The material is deformed in such a way that material regions are deformed towards the outer circumferential surface of the axial portion of the striker in the desired position and come into contact with the outer circumferential surface of the axial portion. The striker is therefore enclosed on the outside. A clamping, pressing or fitting occurs.

The deformation forces and deformation paths are designed in such a way that the threshold force is precisely defined. The threshold force is selected in such a way that, under normal circumstances, the striker is permanently fixed securely and immovably to the mounting plate over the service life of the vehicle, i.e. without a crash situation occurring. At the same time, the threshold forces can be set in such a way that, over the service life of the vehicle, whenever the threshold force, e.g. 1 kN or another threshold force to be set as required, is exceeded, the striker is safely moved from the desired position to the spaced-apart position.

According to an advantageous embodiment of the invention, it is provided that the material regions of the mounting plate, which are arranged at the mouth of the opening, are deformed along a plurality of circumferential regions of the outer circumferential surface of the axial portion in abutment against the outer circumferential surface of the axial portion of the striker in the desired position. This embodiment of the invention enables a particularly safe and precise adjustment of the threshold force, as the deformation movements are distributed over a plurality of circumferential regions.

According to an advantageous embodiment of the invention, the material regions of the mounting plate, which are arranged at the mouth of the opening, are deformed in an annular manner against the outer circumferential surface of the axial portion, abutting against the outer circumferential surface of the axial portion of the striker located in the desired position. This embodiment of the invention allows for a particularly optimized and secure setting of an exact range for the threshold force, as contact forces are distributed over the entire outer circumferential surface of the axial portion.

According to an advantageous embodiment of the invention, the material regions are ring caulked. In this embodiment of the invention, a pusher body encircles the central longitudinal axis of the axial portion. This embodiment of the invention allows particularly suitable, in particular funnel-shaped pusher bodies to be used.

According to an advantageous embodiment of the invention, the material regions are ring caulked in a wobbling manner. This embodiment of the invention allows for particularly secure and exact setting of the threshold force.

According to an advantageous embodiment of the invention, material regions of the mounting plate, which are arranged at both mouths of the opening, are deformed abutting against the outer circumferential surface of the axial portion of the striker located in the desired position. This embodiment of the invention makes it possible to distribute the contact forces over two different axial regions of the axial portion, thereby equalizing the deformation movement and thus defining the threshold force particularly precisely.

According to an advantageous embodiment of the invention, the mounting plate has at least two opening for two different axial portions of the striker. This embodiment of the invention is suitable in particular for stable fastening of a striker with two axial legs to the mounting plate.

According to an advantageous embodiment of the invention, material regions of the mounting plate, which are arranged at a mouth of the first opening and material regions of the mounting plate, which are arranged at a mouth of the second opening, are deformed abutting against the outer circumferential surface of the respective axial portion of the striker located in the desired position. This embodiment of the invention enables a particularly secure setting of the threshold force in a predetermined threshold force range, since a distribution of the decisive deformation of the forces to different ranges is provided.

According to an advantageous embodiment of the invention, the striker is elongated in an axial direction. This embodiment of the invention allows the use of conventional strikers.

According to an advantageous embodiment of the invention, the striker is U-shaped or substantially U-shaped. This embodiment of the invention allows the use of strikers of a conventional construction.

According to an advantageous embodiment of the invention, the adjustment path of the striker from its desired position to its spaced-apart position is at least 20 mm particular at least 40 mm, more particularly at least 50 mm. This embodiment of the invention enables a particularly advantageous and crash-safe design of a locking device.

According to an advantageous embodiment of the invention, stop surfaces are arranged on the striker, which limit its axial displacement movement in one direction or in two directions. This embodiment of the invention enables a particularly secure design of the locking device.

According to an advantageous embodiment of the invention, the striker is radially expanded at an axial region immediately adjacent to the axial portion and immediately adjacent to the material regions. This embodiment of the invention allows for a particularly optimized and secure setting of the threshold force along a precisely predeterminable range and simple production.

According to an advantageous embodiment of the invention, the radial expansion of the striker is bead-shaped. This embodiment of the invention allows for a particularly optimized and secure setting of the threshold force along a precisely predeterminable range and simple production of the locking device.

The invention also relates to a method according to claim 15.

Based on a locking device of the prior art of the type described above, the object of the invention is to provide a method by means of which a locking device can be manufactured in a particularly advantageous manner.

The invention achieves this object with the features of claim 15.

The method according to claim 15 is best understood in appreciation of the claims and features of the preceding embodiments relating to a locking device.

In contrast to the prior art, the method according to the invention does not provide a deformable bead on the striker that defines the threshold force, but instead deforms material areas of the mounting plate in such a way that they come into contact with an outer circumferential surface of an axial portion of the striker. This allows a threshold force to be set precisely and accurately in advance.

According to an advantageous embodiment of the invention, step d) is configured such that an annular contact of the material regions of the mounting plate with an outer circumferential surface of an axial portion is achieved. This embodiment of the invention allows for particularly precise setting of the threshold force.

According to an advantageous embodiment of the invention, step d) is performed with the aid of a pusher body, in particular a funnel-shaped pusher body, which performs an impact and/or wobbling movement to achieve a radially inwardly directed material flow.

This embodiment of the invention enables the desired material flow of the material regions of the mounting plate radially inwards, relative to a central longitudinal axis of the axial portion, in a particularly simple manner.

According to an advantageous embodiment of the invention, the following step is performed after step d):
e) deforming the striker to achieve a radial expansion at an axial region immediately adjacent to the axial portion and immediately adjacent to the material regions.
This embodiment of the invention allows for precise setting of the threshold force.

According to an advantageous embodiment of the invention, to perform step e), a striker is provided that comprises a radial step. This embodiment of the invention allows for particularly simple provision of the striker and a particularly simple option for a radial expansion.

According to an advantageous embodiment of the invention, step e) comprises the following step:
f) caulking the radial step.
This embodiment of the invention allows for particularly simple manufacture.

The invention also relates to a fastening device according to claim 21.

The object of the invention is to provide a fastening device that, with the aid of a rivet, fixes two bodies relative to one another in a simple manner.

The invention achieves this object with the features of claim 21.

The principle of the invention is essentially to provide two bodies—a first body and a second body—wherein both bodies may be formed, for example, by a metal sheet. Each body has an opening, wherein both openings are arranged in alignment with one another.

A rivet passes through both openings. The rivet has an axial portion with a first end and a second end. At the first end, the axial portion has a rivet head that is radially widened. The rivet head is therefore radially larger than the opening and secures the rivet axially to the first body. For this purpose, it has retaining surfaces that are arranged on the widening. The retaining surfaces contact the first body.

At its second end, the axial portion is not equipped with such a rivet head. Instead, similar to the previously described inventions, the particular embodiments of which according to the invention can also be applied in an analogous manner to the subject matter according to claim 21, a deformation of material regions of the second body is carried out here.

Again, material regions of the second body, which are located at the mouth of the second opening, are deformed. As a result of the deformation, the material regions are pressed together, i.e. in contact, against the outer circumferential surface of the axial portion.

This achieves a clamping or press connection between the second body and the rivet in the region of the second end of the axial portion, in particular in the manner described above.

The invention includes when the two bodies are immovably fixed relative to one another. Alternatively, the two bodies can also be pivoted together.

Further advantages of the devices according to the invention are apparent from the sub-claims not mentioned and from the following description of the exemplary embodiments shown in the drawings.

In the drawings:

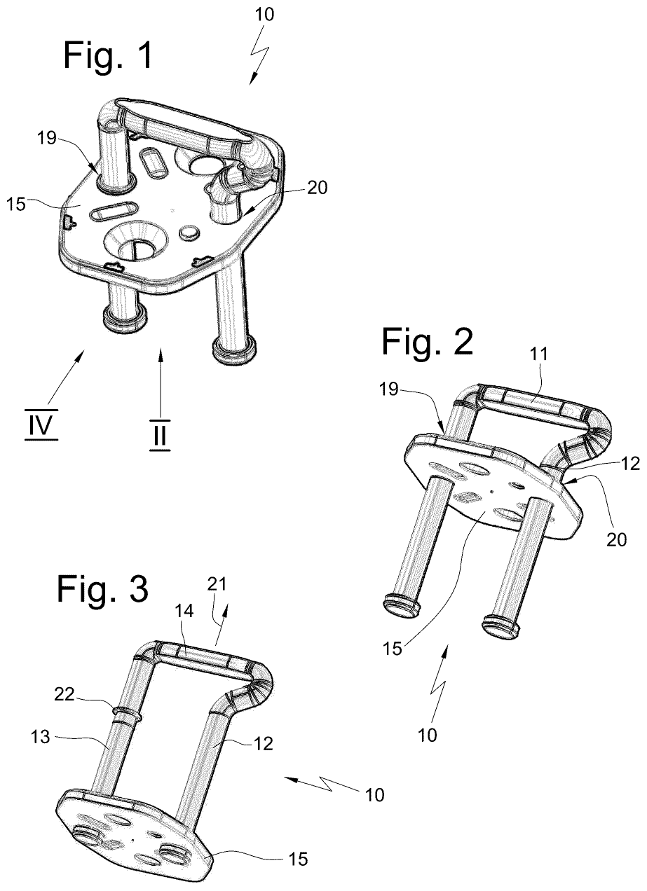

FIG. 1 shows a schematic, perspective view of a first exemplary embodiment of a locking device according to the invention having a striker in a desired position and a mounting plate,

FIG. 2 shows the locking device from FIG. 1 in a schematic oblique view, approximately along the view arrow II in FIG. 1,

FIG. 3 shows the exemplary embodiment from FIG. 2 having a striker in a spaced-apart position,

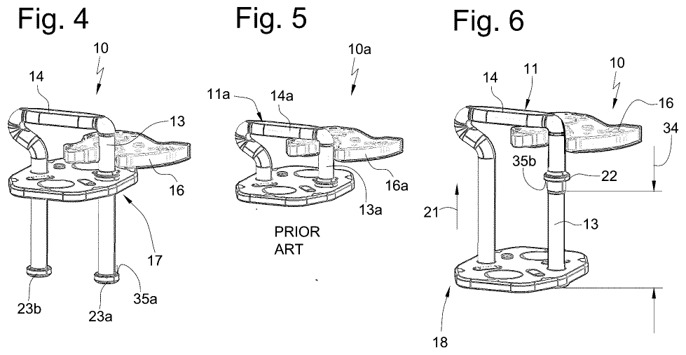

FIG. 4 shows the exemplary embodiment of the locking device from FIG. 1 in a schematic view, approximately along the view arrow IV in FIG. 1, wherein a rotary latch is also shown,

FIG. 5 shows an exemplary embodiment of a locking device from the prior art having a non-displaceable striker in a view similar to the exemplary embodiment from FIG. 4, wherein deformations (not shown) have occurred as a result of a crash, which lead to the rotary latch coming close to a transverse leg of the striker and contacting it while preventing an opening movement,

FIG. 6 shows the exemplary embodiment of a locking device according to the invention from FIG. 4 with a striker in a spaced-apart position in the event of a crash, wherein here the rotary latch has shifted the striker into a spaced-apart position from the mounting plate as a result of the crash situation that has occurred by means of a force applied to the transverse leg of the striker, making it easier to open the locking device,

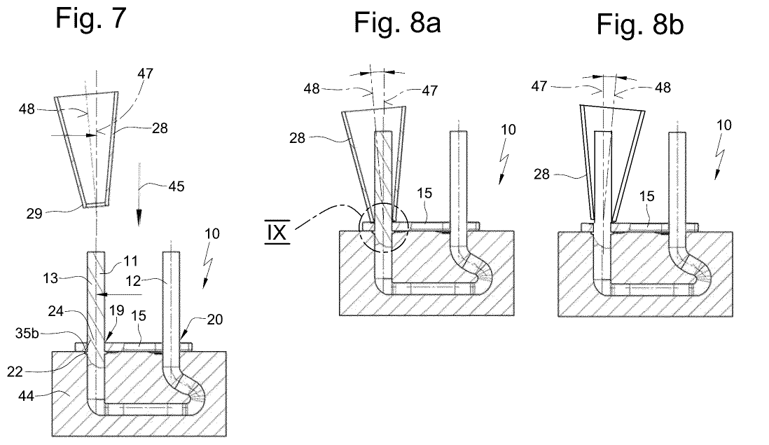

FIG. 7 shows a partial section of a schematic view of a further exemplary embodiment of a locking device according to the invention having a mounting plate and a striker in a desired position, an abutment element, and a funnel-shaped pusher body, which is arranged spaced apart from the striker in the illustration in FIG. 7,

FIG. 8a shows the exemplary embodiment from FIG. 7, in which the funnel-shaped pusher body has been moved towards the mounting plate for the purpose of performing a wobbling deformation movement,

FIG. 8b shows an illustration according to FIG. 8a of the locking device from FIG. 8a, wherein the pusher body is shown in a modified inclination position to illustrate the wobbling movement,

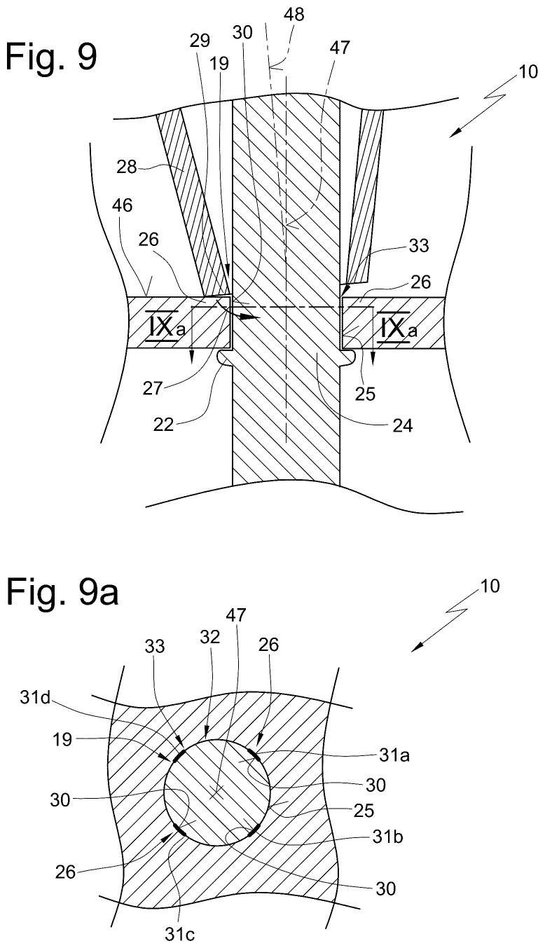

FIG. 9 shows a partial section of an enlarged view approximately according to the pitch circle IX in FIG. 8 of the mounting plate, in the opening of which an axial portion of the striker is arranged, as well as the funnel-shaped pusher body in a broken-off illustration to explain the deformation movement,

FIG. 9a shows the locking device from FIG. 9 in a partial section of a broken-off, schematic cross-sectional illustration, approximately along the section line IXa-IXa in FIG. 9,

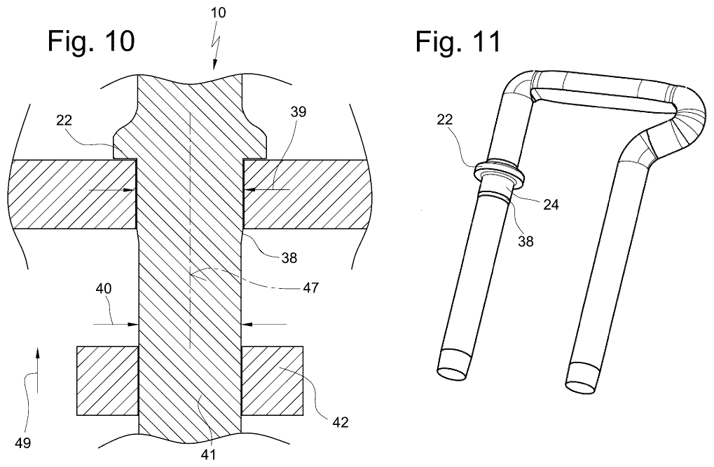

FIG. 10 shows a further exemplary embodiment of a locking device according to the invention in an illustration similar to FIG. 9, in which the material regions of the mounting plate already come into contact with the outer circumferential surface of the axial portion of the striker in the target position due to deformation, wherein the striker has a conical bevel in the form of a radial step,

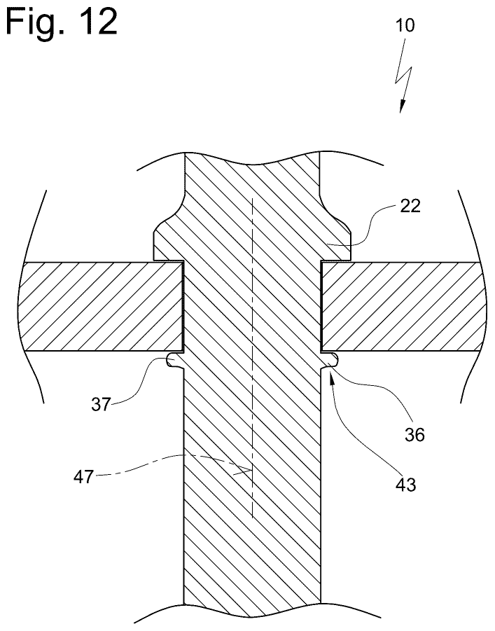

FIG. 11 shows the exemplary embodiment of a striker of a locking device according to the invention according to FIG. 10 in a stand-alone illustration,

FIG. 12 shows the exemplary embodiment from FIG. 10, in which the radial step is deformed into a bead in the form of a radial expansion, and

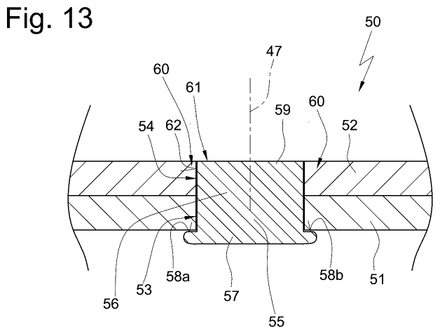

FIG. 13 shows a schematic, partial section of an illustration of an exemplary embodiment of a fastening device according to the invention having a first head and a second head, as well as a rivet.

The exemplary embodiments of the invention are explained with reference to the following description of the drawings:

Exemplary embodiments of the invention are described in the following figure description, additionally with reference to the drawings. For the sake of clarity—also as far as different embodiments are concerned—identical or comparable parts or elements or regions are designated with the same reference numerals, sometimes with the addition of lowercase letters.

Features described only in relation to one embodiment may also be provided in any other embodiment of the invention within the scope of the invention. Such modified embodiments—even if not shown in the drawings—are covered by the invention.

All disclosed features are essential to the invention in themselves. The disclosure of the application hereby also includes in full the disclosure content of associated priority documents (copy of the prior application) as well as cited publications and the described prior art devices, also for the purpose of including individual or several features of these documents in one or several claims of the present application.

A first exemplary embodiment of a locking device according to the invention is shown in FIGS. 1 to 3 and is designated in its entirety by the reference numeral 10.

The locking device 10 according to the invention comprises a striker 11. This can be made from a round steel, for example. In the exemplary embodiment in the figures, the striker 11 comprises a first leg 12 and a second leg 13, which are connected to each other by a transverse leg 14. The first leg 12 passes through an opening 20 in the mounting plate and the second leg 13 passes through an opening 19 in the mounting plate. FIGS. 1 and 2 show the striker 11 in a desired position 17.

In the event of a crash, forces can be exerted on the striker 11 relative to the mounting plate 15 in the axial direction 21. If these forces exceed a threshold force, e.g. a force greater than 1 kN or greater than 2 kN, or e.g. greater than 3 kN, the striker 11 can move in the axial direction 21. FIG. 3 shows a spaced-apart position 18, which is achieved in the event of a crash.

In normal operation of the vehicle, the striker 11 remains in the desired position 17. Here, for example, the mounting plate 15 can be fixed on the body side and a rotary latch 16 arranged on a door element can restrain the striker 11. The invention also comprises a geometrically inverted arrangement in which the mounting plate 15 and the striker 11 are fixed to a door element and the rotary latch 16 is arranged on the body side.

FIGS. 4 and 6 illustrate the previously described locking device 10 in a further additional representation of a rotary latch 16. The rotary latch 16 is shown in FIGS. 4 to 6 and grips or restrains the leg 13 of the striker 11. FIG. 4 shows the usual position with the door closed and locked. This normal state of the striker is maintained when the door is closed and locked for the life of the vehicle, as long as a crash does not occur.

In the event of a crash, e.g. a side impact accident or a head-on collision, the situation may arise with a locking device 10a of the prior art as shown in FIG. 5, which has a non-displaceable striker 11a, that the transverse leg 14a comes into contact with the rotary latch 16a as a result of a relative deformation of the door element and/or body and/or rotary latch in the event of a crash. FIG. 5 shows this situation.

In such a contact situation, the rotary latch 16a cannot be displaced into its open position, for example as a result of deformation of the rotary latch 16a relative to the transverse leg 14a of the striker 11a, or as a result of deformation of other elements of the locking device 10a that are not shown, or as a result of deformation of vehicle parts arranged adjacent to the locking device 10a that are also not shown. As a result of these aforementioned deformations, an opening movement of the rotary latch is not possible without problems, for example because a portion of the rotary latch 16a comes into contact with a portion of the striker 11a during an opening movement, thereby blocking an opening movement of the rotary latch 16a. This means that the door cannot be opened.

In order to prevent such blockages, the striker 11 of the locking device 10 according to the invention is movable and can reach a spaced-apart position 18 in the event of a crash, as illustrated in FIG. 6.

With regard to the illustration in FIG. 6, it is now assumed that similar or comparable deformations and similar or the same forces occur in the event of a crash as in the exemplary embodiment shown in FIG. 5. In the device 10 according to the invention, the rotary latch 16 can exert a force directed in the direction of the arrow 21 on the transverse leg 14 of the striker 11 in the course of a crash and entrain the striker 11 in the direction of the arrow 21 until it reaches a spaced-apart position 18 shown in FIG. 6.

In this spaced-apart position 18, an unhindered opening movement of the rotary latch 16 relative to the displaced striker 11 is possible despite the deformation of the body and/or despite the deformation of the door element (not shown in the figures). In particular, the opening movement is possible because the rotary latch 16 is not deformed relative to the striker 11, or is not deformed as much, during the displacement of the striker 11, so that no blockage occurs during an opening movement of the rotary latch 16 carried out after the crash.

In particular, during an opening movement of the rotary latch 16 after the crash, the transverse leg 14 of the striker 11 is not contacted by the rotary latch 16. The door can be released when the locking device is opened.

Referring to FIGS. 7 to 9a, the principle according to the invention will now be explained with reference to an exemplary embodiment of a locking device 10.

FIG. 7 shows a striker 11, which is fixed in its desired position on a mounting plate 15. The leg 13 passes through a first opening 19 on the mounting plate 15 and the second leg 12 passes through a second opening 20.

Both openings 19, 20 are dimensioned so that the two legs 12, 13 can be easily inserted.

FIG. 7 shows a position in which the stop element 22 rests with its stop surface 35b against the lower side of the mounting plate 15 with respect to FIG. 7.

This contact defines the desired position 17 of the striker 11 relative to the mounting plate 15.

As shown in FIG. 7, the mounting plate 15 is placed on the abutment 44 and therefore cannot move out of position when force is exerted on the mounting plate 15 from above as shown in FIG. 7.

FIG. 7 indicates, at a distance from the locking device 10, a pusher body 28 or a pusher element in the form of a funnel. The funnel 28 is pushed over the leg 13 of the striker 11 along the direction of the arrow 45 until it rests with its free edge 29 on the mounting plate 15. FIGS. 8a, 8b and 9 show this position.

The pusher body 28 is actuated by a drive device (not shown) in the direction of the arrow 45, i.e. towards the mounting plate 15.

The pusher body 28 presses its free end 29 (as shown in FIG. 9) onto the upper side 46 of the mounting plate 15 in such a way that material regions 26 of the mounting plate 15 flow radially inwards at the mouth 33 of the first opening 19 along the direction of deformation of the arrow 27.

The portion of the striker 11 located inside the first opening 19 is referred to as the axial portion 24. The central longitudinal axis of the axial portion 24 is designated by the reference numeral 47. The material regions 26 of the mounting plate 15 are moved towards the central longitudinal axis 47 of the axial portion 24 in the course of the deformation movement.

The deformation movement takes place in such a way that the material regions 26 of the mounting plate 15 contact the outer circumferential surface 25 of the axial portion 24.

The sectional view of FIG. 9a illustrates corresponding contact regions 30 of these material regions 26.

The pusher body 28 performs a wobbling movement, driven by the drive device (not shown). This is illustrated by comparing FIGS. 8a and 8b.

The pusher body 28 has a central longitudinal axis 48. As a result of the wobbling movement, the central longitudinal axis 48 of the pusher body 28 rotates about the central longitudinal axis 47 of the axial portion 24.

As a result of the continuously changing inclination position or wobble positions of the pusher body 28 relative to the mounting plate 15, pressure is exerted along the direction of the arrow 45 and at the same time radially inwards, towards the central axis 48 of the axial section 24, so that the radial deformation movement of the material regions 26 is achieved.

As a result of the wobbling movement of the pusher body 28, different portions of the free edge 29 of the pusher body 28 come into contact with the upper side 46 of the mounting plate 15. These contact portions, or more precisely those regions of the free edge 29 of the pusher body 28 that effect a deformation movement of the material regions 26, propagate in a circular ring around the edge of the opening 19, i.e. in a circle around the central longitudinal axis 47 of the axial portion 24.

Such a wobbling movement can be continuous. However, the invention also comprises impulse-like or impact-like pushing movements of the pusher body 28 on the upper side of the mounting plate 15, e.g. in the manner of hammer blows.

FIG. 9a shows that along the mouth 33 of the opening 19, a plurality of circumferential regions 31a, 31b, 31c, 31d provide contact surfaces 30 that contact the outer circumferential surface 25 of the axial portion 24.

In particular, according to the invention, it is provided that the mouth 33 provides an annular region 32 that completely surrounds the outer circumferential surface 25 of the axial portion 24, which is closed in the direction of rotation, i.e. it fits snugly.

This deformation movement of the material regions 26, achieved by a wobbling pusher body 28, allows the threshold force required in the event of a crash to be set to a very precisely predetermined degree in order to move the striker 11 from the desired position 17 to the spaced-apart position 18.

The adjustment path 34 can be 50 mm, for example.

As FIGS. 7 and 9 show, this pusher body 28 is essentially funnel-shaped and tapers downwards. The lower mouth end of the pusher body 28 has an internal diameter at its free edge areas 29 that is larger than the external diameter 39 of the axial portion 24. For example, the inner diameter at the funnel mouth of the pusher body 28 can be approximately 1 mm-4 mm larger than the outer diameter 39 of the axial portion 24.

Advantageously, it can be provided that the inner free edge 29 of the pusher body 28 has a distance from the outer circumferential surface 25 of the axial portion 24 of between 0.5 mm and 2 mm.

The illustration in FIG. 9 is only schematic and, in particular, not to scale.

An end stop 23a, 23b (FIG. 4) can be provided at the free end of a leg 12, 13 of the striker or both legs of the striker 11, with a corresponding stop surface 35a, which limits the movement of the striker 11 in the event of a crash.

The invention includes when only one leg 12, 13 is locked in the desired position by the previously described deformation movement of material regions 26 of the mounting plate 15 for setting the threshold force. The invention also includes both legs 12, 13 being fixed to the mounting plate 15 in this way.

In the exemplary embodiment of FIGS. 10 to 12, in addition to the previously described fixing of the striker 11 to the mounting plate 15 as a result of deformation of material regions 26 of the mounting plate 15, the following is also provided: FIG. 11 shows a further exemplary embodiment of a striker 11 according to the invention in a perspective, schematic view.

The axial portion 24 and the stop bead 22 can be seen. The special feature of this exemplary embodiment is a radial step 38, which is conical in shape.

Compared to the outer diameter 39 of the axial portion 24, the outer diameter 40 of the adjoining axial portion 41 is smaller.

FIG. 10 illustrates this offset of the outer diameter in the sectional view. The step is linear so that a taper is achieved.

FIG. 10 illustrates a further pusher body 42 in the form of a circular ring cylindrical hollow pusher, the inside diameter of which is matched to the outer diameter 40 of the axial portion 41.

As a result of a movement along the arrow 49, the pusher body 42 can caulk the radial step 38, starting from the position shown in FIG. 10. FIG. 12 schematically shows the caulked radial step 43.

The radial step 38 has been caulked to form a radial expansion 36.

In the exemplary embodiment of FIG. 10, the radial expansion 36 is illustrated by means of a bead 37.

In the event of a crash, the bead 37 also prevents the striker 11 from moving from the target position 17 to the spaced-apart position 18 and this bead 37 must also be deformed in the event of a crash.

By forming such a radial expansion 36, the threshold force required to displace the striker 11 from the target position 17 to the spaced-apart position 18 can be adjusted even better and more precisely.

By carrying out two different deformations, wherein on the one hand the radially inward deformation of the material regions 26 of the mounting plate 15 and on the other hand a radial expansion 36 of the leg 12, 13 of the striker 11 is carried out independently of this, the threshold force can be set even more precisely as a result of a division into two deformation regions.

FIG. 13 shows an exemplary embodiment of a fastening device 50 according to the invention.

A first body 51 is provided here, which is provided, for example, by a metal sheet, and a second body 52, which is also provided, for example, by a metal sheet.

An opening 53 is arranged in the first body 51 and a second opening 54 is arranged in the second body 52. The openings 53, 54 are arranged in alignment with one another.

A rivet 55 passes through both openings 53, 54.

The rivet 55 comprises an axial portion 56 and a rivet head 57. The rivet head 57 comprises retaining surfaces 58a, 58b, wherein these retaining surfaces 58a, 58b are formed as an annular end face and contact the first body 51.

The rivet 55 has a second 59.

The second opening 54 is surrounded by material regions 60 of the second body 52.

In the region of the mouth 61 of the second opening 54, material regions 60 of the second body 52 are also deformed radially inwards, towards the central longitudinal axis 47 of the rivet 55, so that they come into contact there with the outer circumferential surface 62 of the axial portion 56.

Again, the rivet 55 can be fixed axially to the second body 52 in this way.

The method for deforming the material regions 60 of the second body 52 can be analogous to the deformation methods of the material regions 26 of the mounting plate 15 of the manner described with respect to the exemplary embodiments of FIGS. 1 to 12. The deformation methods described in the exemplary embodiments of FIGS. 1 to 12 and all other features disclosed therein can be applied equally to the exemplary embodiment of a fastening device according to FIG. 13. Again, ring compression or ring caulking can be achieved by a wobbling pusher body 28.

In an exemplary embodiment of the fastening device 50, the first body 51 and the second body 52 are immovably fixed relative to one another.

In an alternative embodiment of the invention, the first body 51 can be arranged pivotably relative to the second body 52 about the central longitudinal axis 47 of the rivet 55.

1-24. (canceled)

25. A locking device for a motor vehicle, comprising: a mounting plate; and a striker fixed in a desired position on the mounting plate and transferable from the desired position to a spaced-apart position in an accident situation as a result of a threshold force being exceeded, wherein the mounting plate comprises at least one opening through which an axial portion of the striker passes, wherein material regions of the mounting plate that are arranged at a mouth of the opening, are deformed in abutment against an outer circumferential surface of the axial portion of the striker located in the desired position.

26. The locking device according to claim 25, wherein the material regions of the mounting plate that are arranged at the mouth of the opening, are deformed along a plurality of circumferential regions of the outer circumferential surface of the axial portion abutting against the outer circumferential surface of the axial portion of the striker located in the desired position.

27. The locking device according to claim 25, wherein the material regions of the mounting plate that are arranged at the mouth of the opening, are deformed in an annular manner against the outer circumferential surface of the axial portion, abutting against the outer circumferential surface of the axial portion of the striker located in the desired position.

28. The locking device according to claim 25, wherein the material regions are ring caulked.

29. The locking device according to claim 28, wherein the material regions are ring caulked in a wobbling manner.

30. The locking device according to claim 25, wherein the material regions of the mounting plate that are arranged at both mouths of the opening, are deformed abutting against the outer circumferential surface of the axial portion of the striker located in the desired position.

31. The locking device according to claim 25, wherein the mounting plate has at least two openings for two different axial portions of the striker.

32. The locking device according to claim 31, wherein material regions of the mounting plate that are arranged at the mouth of the first opening and material regions of the mounting plate that are arranged at a mouth of the second opening, are deformed abutting against the outer circumferential surface of the respective axial portion of the striker located in the desired position.

33. The locking device according to claim 25, wherein the striker is elongated in an axial direction.

34. The locking device according to claim 25, wherein the striker is U-shaped or substantially U-shaped.

35. The locking device according to claim 25, wherein an adjustment path of the striker from the desired position to the spaced-apart position is at least 20 mm.

36. The locking device according to claim 35, wherein the adjustment path of the striker from the desired position to the spaced-apart position is at least 40 mm.

37. The locking device according to claim 36, wherein the adjustment path of the striker from the desired position to the spaced-apart position is at least 50 mm.

38. The locking device according to claim 25, further comprising stop surfaces arranged on the striker so as to limit axial displacement movement of the striker in one direction or in two directions.

39. The locking device according to claim 25, wherein the striker has a radial expansion at an axial region that is directly adjacent to the axial portion and is directly adjacent to the material regions.

40. The locking device according to claim 39, wherein the radial expansion of the striker is bead-shaped.

41. A method for producing a locking device for a motor vehicle, comprising the steps of:
a) providing a striker;
b) providing a mounting plate having at least one opening;
c) arranging an axial portion of the striker in the opening; and
d) deforming material regions of the mounting plate at a mouth of the opening against an outer circumferential surface of the axial portion so that the material regions contact the outer circumferential surface.

42. The method according to claim 41, including performing step d) so that an annular contact of the material regions with the outer circumferential surface is achieved.

43. The method according to claim 41, including performing step d) using a pusher body that carries out an impact and/or wobbling movement to achieve a radially inwardly directed material flow of the material region.

44. The method according to claim 43, wherein the pusher body is funnel-shaped.

45. The method according to claim 41, further comprising, following step d), the step of:
e) deforming the striker to achieve a radial expansion at an axial region immediately adjacent to the axial portion and immediately adjacent to the material regions.

46. The method according to claim 45, including providing, to perform step e), a striker that comprises a radial step.

47. The method according to claim 46, further including, after step e), the step of:
f) caulking the radial step.

48. A fastening device for relatively fixing a first body to a second body, wherein the first body comprises a first opening and wherein the second body comprises a second opening, wherein the first and second openings are in alignment with one another, wherein a rivet passes through both openings, wherein the rivet has an axial portion with a rivet head at a first end that is radially widened relative to the axial portion, and secures an axial position of the rivet with retaining surfaces that contact the first body, and wherein the axial portion of the rivet is contacted at a second end on an outer circumferential surface by material regions of the second body surrounding a mouth of the second opening, wherein the material regions of the second body are deformed to abutt against the outer circumferential surface of the axial portion of the rivet.

49. The fastening device according to claim 48, wherein at least one of the first body and the second body is formed from a metal sheet.

50. The fastening device according to claim 48, wherein the first and second bodies are immovably fixed relative to one another.

51. The fastening device according to claim 48, wherein the first body is pivotable relative to the second body.
